(19) United States
(12) Patent Application Publication
(10) Pub. No.: US 2025/0353313 A1
(43) Pub. Date: Nov. 20, 2025

(54) PRINTING APPARATUS, CONTROL METHOD, AND STORAGE MEDIUM

(71) Applicant: CANON KABUSHIKI KAISHA, Tokyo (JP)

(72) Inventors: YUSUKE IINO, Kanagawa (JP); YUMI SUZUKI, Tokyo (JP); SHIMPEI SHINOHARA, Kanagawa (JP); TAKAHIRO KIUCHI, Tokyo (JP); KEN TAKENAGA, Kanagawa (JP); KATSUAKI SUKEGAWA, Kanagawa (JP); NORIYUKI SUGIYAMA, Kanagawa (JP)

(21) Appl. No.: 19/206,650

(22) Filed: May 13, 2025

(30) Foreign Application Priority Data
May 16, 2024 (JP) 2024-080374

(51) Int. Cl. B41J 3/60; B41J 13/00; B41J 25/00

(52) U.S. Cl. CPC B41J 3/60; B41J 13/0027; B41J 25/005

(57) ABSTRACT

A printing apparatus includes a first conveyance unit for conveying a print medium, a printing unit for printing by discharging ink, a second conveyance unit for conveying the print medium printed by the printing unit, and a reversal conveyance unit for reversing the print medium whose first surface is printed and conveying it to the first conveyance unit, wherein an edge region on an upstream side in a conveyance direction in a case of printing on the first surface is defined as a first edge region, and in a case that the printing unit prints on a second surface of the print medium, a conveyance speed of the print medium until the print medium from the reversal conveyance unit reaches the second conveyance unit changes depending on an ink discharge amount in the first edge region.

### BACKGROUND

### Field

The present disclosure relates to a printing apparatus and, more particularly, to a printing apparatus, control method, and storage medium capable of performing double-sided printing.

### Description of the Related Art

A printing apparatus represented by an inkjet printer generally conveys a print medium in an appropriate posture to prevent a printing position deviation for the print medium (a paper material such as a sheet).

In a case of double-sided printing in which after the obverse surface of a print medium is printed, the reverse surface is further printed, the posture of the print medium when printing the reverse surface may change depending on the print mode of the obverse surface, and additional contrivance is needed to implement more appropriate printing. Note that a platen structure capable of suppressing floating of a print medium in a printing apparatus is described in Japanese Patent Laid-Open No. H11-245457, but the above-described problem in a case of double-sided printing is not recognized.

### SUMMARY

The present disclosure has been made based on recognition of the above-described problem and provides a technique advantageous in appropriately implementing double-sided printing.

According to some embodiments, a printing apparatus includes a first conveyance unit configured to convey a print medium, a printing unit configured to perform printing by discharging ink to a first surface of the print medium conveyed by the first conveyance unit and a second surface opposite to the first surface, a second conveyance unit configured to convey the print medium printed by the printing unit, and a reversal conveyance unit configured to reverse the print medium whose first surface is printed by the printing unit and convey the print medium to the first conveyance unit to print the second surface by the printing unit, wherein an edge region on an upstream side in a conveyance direction in a case that the printing unit performs printing on the first surface is defined as a first edge region, and in a case that the printing unit performs printing on the second surface of the print medium with the printed first surface, a conveyance speed of the print medium until the print medium from the reversal conveyance unit reaches the second conveyance unit changes depending on an ink discharge amount in the first edge region.

Further features of the present disclosure will become apparent from the following description of exemplary embodiments (with reference to the attached drawings).

### BRIEF DESCRIPTION OF THE DRAWINGS

FIG. 1 is a perspective view showing an example of the internal structure of a printing apparatus according to an embodiment.

FIGS. 2A and 2B are schematic sectional views showing the printing apparatus so as to explain a conveyance path.

FIG. 3 is a block diagram showing an example of the system configuration of the printing apparatus.

FIG. 4 is a schematic side view showing the configuration of a printing unit of the printing apparatus.

FIG. 5 is a schematic view for explaining a printing region on each of the obverse surface side and the reverse surface side of a sheet.

FIG. 6 is a flowchart showing an example of a method of print control.

FIG. 7 is a schematic view showing an example of a method of evaluating an ink discharge amount in an obverse surface trailing edge region.

FIGS. 8A and 8B are schematic views showing print modes in a normal mode and a low-speed mode.

FIG. 9 is a view for explaining a wait time until the start of printing.

FIGS. 10A, 10B, and 10C are timing charts for explaining the relative relationship between a sheet conveyance speed and a printhead scanning speed in one scan printing.

### DESCRIPTION OF THE EMBODIMENTS

Hereinafter, various exemplary embodiments, features, and aspects of the present disclosure will be described in detail with reference to the attached drawings. Note, the following embodiments are not intended to limit the scope of the claimed invention. Multiple features are described in the embodiments, but limitation is not made to a configuration that use all such features, and multiple such features may be combined as appropriate. Furthermore, in the attached drawings, the same reference numerals are given to the same or similar configurations, and redundant description thereof is omitted.

### First Embodiment

### <Overall Configuration of Printing Apparatus

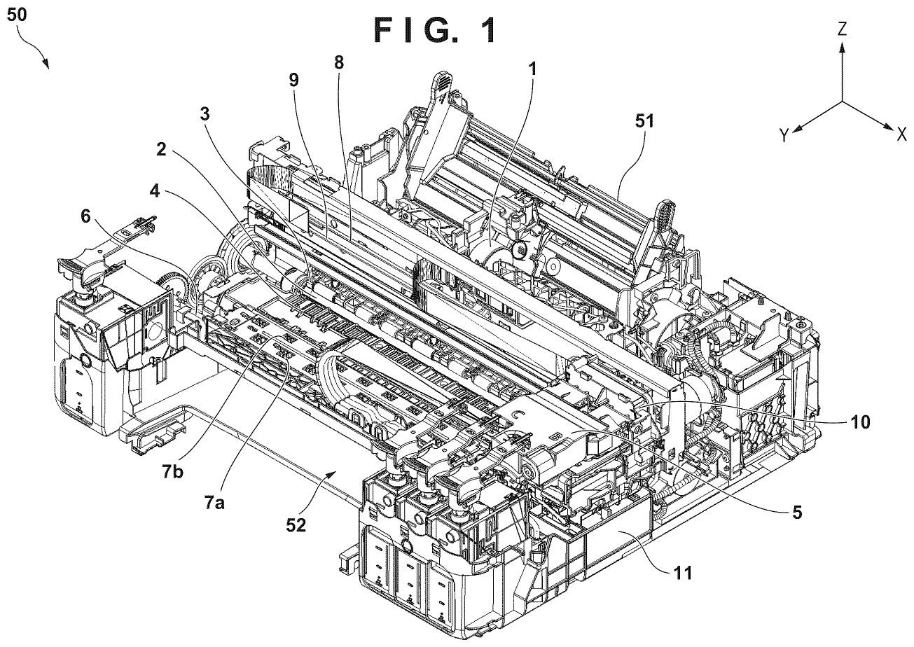

FIG. 1 is a perspective view showing an example of the internal structure of a printing apparatus 50 according to the first embodiment. In this embodiment, the printing apparatus 50 is an inkjet printer including a printhead 5 that prints by discharging ink to a print medium. Here, printing indicates forming an image by ink discharged to a print medium. The concept of an image includes a character, a number, a symbol, a graphic, and a photograph, and can also include a space formed therebetween. A typical example of the print medium is a paper material such as a cut sheet, and this will simply be expressed as a sheet in the following explanation.

Here, to facilitate understanding of an apparatus structure, the X direction, the Y direction, and the Z direction, which cross each other or are substantially orthogonal to each other are shown in the drawings (the same applies to other drawings to be described later). The X direction corresponds to the left/right direction or the widthwise direction, the Y direction corresponds to the front/rear direction or the depth direction, and the Z direction corresponds to the up/down direction or the height direction.

The printing apparatus 50 further includes a paper feed roller 1, a first conveyance roller 2, a pinch roller 3, a platen 4, a second conveyance roller 6, spurs 7a and 7b, guiderails 8 and 9, a carriage 10, a recovery unit 11, a paper feed unit 51, and a discharge unit 52.

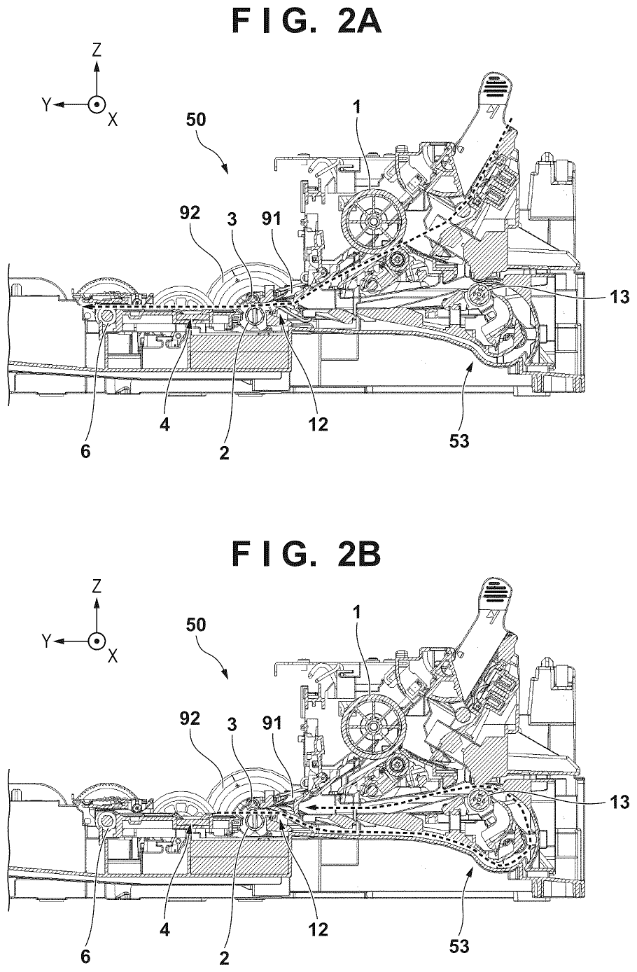

FIGS. 2A and 2B are schematic sectional views showing the printing apparatus 50 so as to explain a sheet conveyance path. The printing apparatus 50 further includes a sheet sensor 12, a relay roller 13, a leading edge detection sensor 91, and a code wheel 92.

A sheet is placed on the paper feed unit 51. If there are two or more sheets, these are stacked on the paper feed unit 51. The paper feed roller 1 can receive the sheet placed on the paper feed unit 51 one by one from the paper feed unit 51 and supply this into the apparatus main body.

The conveyance roller 2 is a driving roller that is arranged on the upstream side of the printhead 5 (a side in a direction along the conveyance direction of the sheet is called an upstream side, and the opposite side is called a downstream side), and rotates upon receiving power from a power source such as an electric motor. The conveyance roller 2 can convey the sheet supplied from the paper feed unit 51 by the paper feed roller 1 to the printhead 5. The pinch roller 3 is a driven roller arranged to abut against the conveyance roller 2 and clamps the supplied sheet in cooperation with the conveyance roller 2. In this way, the conveyance roller 2 and the pinch roller 3 convey the supplied sheet to the printhead 5.

The platen 4 is arranged facing the printhead 5 and supports the sheet as the print target from the side opposite to the printhead 5.

Here, the printhead 5 is mounted on the carriage 10 that can slide in the X direction along the guiderails 8 and 9. The carriage 10 can reciprocally move in the X direction along the guiderails 8 and 9 upon receiving power from a power source such as an electric motor, and thus causes the printhead 5 to scan in the X direction. During the scanning, the printhead 5 can execute printing on the sheet based on print data.

In this embodiment, an operation of conveying the sheet by a predetermined amount by the conveyance roller 2 (and additionally by the conveyance roller 6) and suppressing the conveyance (intermittent conveyance) and an operation of printing the sheet by scanning of the printhead 5 during suppression of the conveyance (scan printing) are alternately performed. By repetitively performing intermittent conveyance and scan printing, printing on the whole sheet is performed. The printhead 5 is also expressed as a serial head, and the printhead 5, the platen 4, and the carriage 10 (and additionally the guiderails 8 and 9) in this configuration may be expressed as a printing unit together.

The recovery unit 11 is arranged at an end portion of the movable range of the printhead 5 by the carriage 10 and can perform recovery processing of the printhead 5 outside a region where printing on the sheet is performed. An example of recovery processing is suction processing for removing bubbles or ink with high viscosity in the printhead 5 by suction, and the function of the printhead 5 is thus recovered. The concept of function recovery includes maintaining the function of the printhead 5 and, for example, recovery processing may be processing of preliminarily discharging ink from the printhead 5.

The leading edge detection sensor 91 is arranged on the upstream side of the conveyance roller 2 and can detect a sheet leading edge (the end of the sheet on the downstream side). As the leading edge detection sensor 91, a known mechanical or optical sensor can be used. The code wheel 92 is provided as a part of an encoder (not shown). For example, an optical sensor detects the rotation amount of the code wheel 92, thereby calculating or specifying the conveyance amount of the sheet. According to this configuration, after the sheet leading edge is detected by the leading edge detection sensor 91, the position of the sheet leading edge can be calculated or specified based on the detection result of the optical sensor.

### <Single-Sided Printing>

In a case where printing is performed only for the obverse surface (one surface or a first surface) of a sheet (in a case of so-called single-sided printing), the sheet printed by the printhead 5 is directly discharged to the discharge unit 52 by the conveyance roller 6 to be described later, as shown in FIG. 2A.

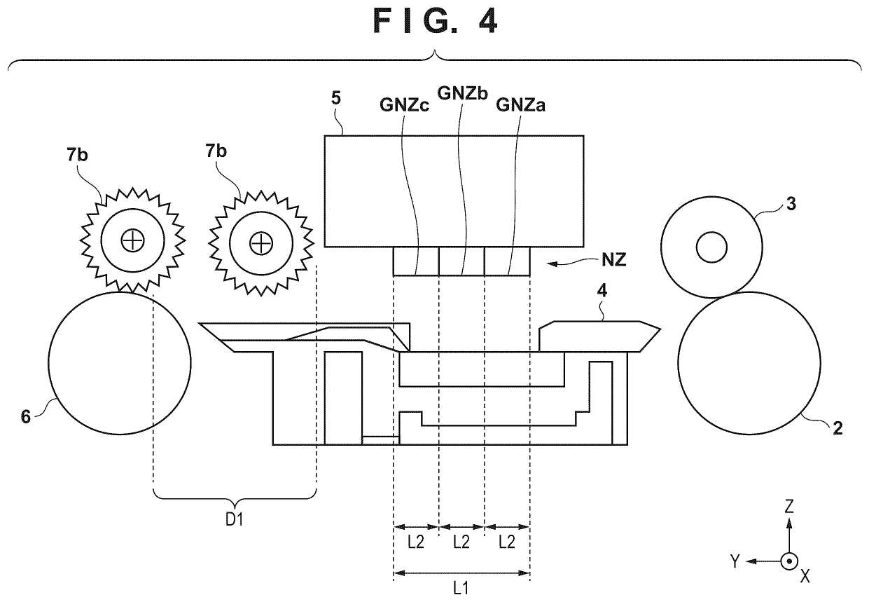

On the downstream side of the printhead 5, the conveyance roller 6 that is driven like the conveyance roller 2, and the rotatable spurs 7a and 7b are arranged. The spurs 7a and 7b are rollers with grooves, which are configured to make the contact surface to the sheet printed by the printhead 5 small, and their roll surfaces have, for example, an uneven shape. The spur 7a is arranged on the downstream side of the spur 7b, and the conveyance roller 6 is arranged facing the spur 7a (see FIG. 4). The spur 7b is arranged between the printhead 5 and the conveyance roller 6 to regulate, to the side of the platen 4, the sheet that may float from the platen 4 during printing and direct the conveyance direction of the sheet to between the conveyance roller 6 and the spur 7a. The conveyance roller 6 discharges the printed sheet to the discharge unit 52 in cooperation with the spur 7a.

The sheet sensor 12 is arranged such that it can detect whether a sheet as a conveyance target reaches the conveyance roller 2 (the presence/absence of a sheet), and drive control of the conveyance rollers 2 and 6 can be performed based on the detection result of the sheet sensor 12. In the following explanation, the conveyance roller 2 and the conveyance roller 6 will sometimes be expressed as the upstream-side conveyance roller 2 and the downstream-side conveyance roller 6, respectively, for the sake of discrimination.

The sheet whose obverse surface is thus printed is further conveyed by the downstream-side conveyance roller 6 while being regulated by the spurs 7a and 7b, and discharged to the discharge unit 52.

### <Double-Sided Printing>

On the other hand, in a case where printing is performed for the reverse surface (the other surface or the second surface) of the sheet as well (in a case of so-called double-sided printing), the sheet is conveyed to the relay roller 13 by reversely rotating the conveyance roller 2 (and additionally the conveyance roller 6), as shown in FIG. 2B. In this embodiment, another conveyance path different from the conveyance path from the paper feed roller 1 to the upstream-side conveyance roller 2 is provided as a reversal conveyance path on the upstream side of the conveyance roller 2, and the relay roller 13 is arranged, as a part of a reversal conveyance mechanism 53, on the reversal conveyance path.

The sheet conveyed to the reversal conveyance mechanism 53 is reversed on the reversal conveyance path, and conveyed to the conveyance roller 2 again by the relay roller 13. That is, the reversal conveyance mechanism 53 receives the sheet whose obverse surface is printed from the upstream-side conveyance roller 2 and reverses it, and conveys the reversed sheet to the upstream-side conveyance roller 2 by the relay roller 13 to further print the reverse surface by the printhead 5.

In this way, further printing is performed for the reverse surface of the sheet conveyed to the printhead 5 again. The sheet whose obverse surface and reverse surface are both printed is further conveyed to the downstream-side conveyance roller 6 while being regulated by the spurs 7a and 7b, and discharged to the discharge unit 52.

Note that the reversal conveyance path of the sheet need only be formed to return the sheet with the printed obverse surface to the printing unit, and is not limited to this configuration. For example, the sheet from the reversal conveyance mechanism 53 may be conveyed to the printing unit by another conveyance roller different from the upstream-side conveyance roller 2.

### <System Configuration>

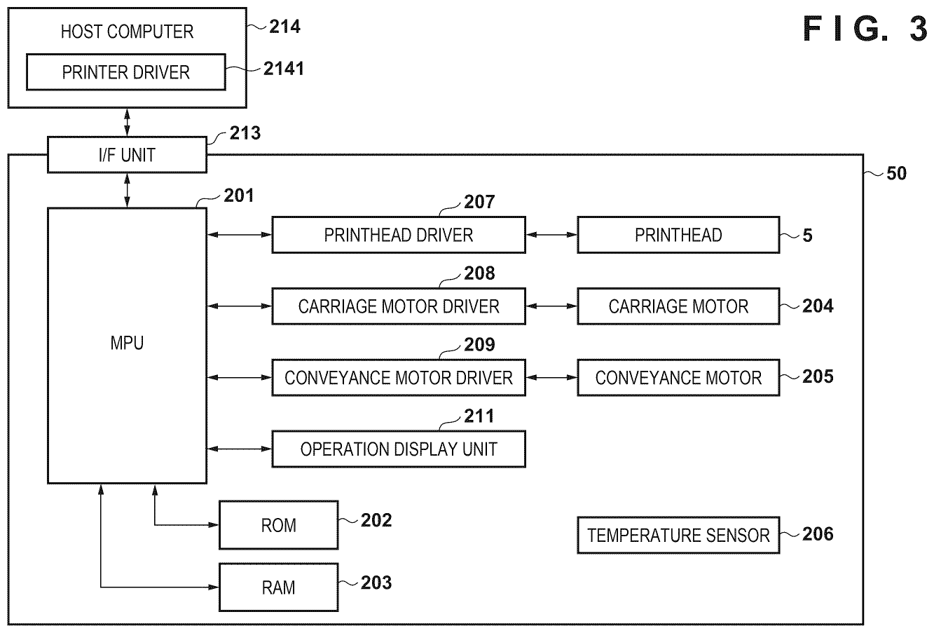

FIG. 3 is a block diagram showing an example of a system configuration configured to perform drive control of the above-described elements provided in the printing apparatus 50. The printing apparatus 50 further includes a micro processing unit (MPU) 201, a read only memory (ROM) 202, a random access memory (RAM) 203, a carriage motor 204, a conveyance motor 205, a temperature sensor 206, a printhead driver 207, a carriage motor driver 208, a conveyance motor driver 209, an operation display unit 211, and an interface (I/F) unit 213.

The MPU 201 performs arithmetic processing for performing drive control of the entire system of the printing apparatus 50. The ROM 202 stores programs and various kinds of parameters used to execute printing. The RAM 203 functions as a work memory.

For example, a host computer 214 that is an external apparatus generates print data by a printer driver 2141 in accordance with input of a print job including image data indicating an image to be printed and setting data used to set printing quality and the like. The MPU 201 receives print data from the host computer 214 via the I/F unit 213. The MPU 201 reads out a desired program from the ROM 202, executes it, performs arithmetic processing based on the print data, and generates various kinds of signals for performing drive control of the elements while storing temporary data in the RAM 203.

The carriage motor driver 208 drives the carriage motor 204 based on a signal from the MPU 201 and reciprocally moves the carriage 10, thereby scanning the printhead 5. Also, the conveyance motor driver 209 drives the conveyance motor 205 based on a signal from the MPU 201, thereby rotating the conveyance rollers 2 and 6. The printhead driver 207 drives the printhead 5 based on a signal from the MPU 201, thereby executing printing. In this way, the MPU 201 repetitively performs the above-described intermittent conveyance and scan printing, and executes printing on sheets one by one.

The temperature sensor 206 can detect the temperature of a power source including the motors 204 and 205.

Also, the operation display unit 211 is typically a touch panel display. The operation display unit 211 can accept an operation input from a user and can also display information based on a signal from the MPU 201.

### <Conveyance When Printing Reverse Surface>

In a case of double-sided printing, deflection may occur in the sheet at the time of printing of the reverse surface depending on the ink discharge amount used to print the obverse surface (the amount of ink discharged to the obverse surface). Deflection here indicates floating from the platen 4 caused by discharge of a relatively large amount of ink to the sheet, for example, warpage, curve, distortion, or the like. The deflection causes position deviation of printing (deviation of the landing position of ink) and may also be a cause to impede appropriate conveyance of the sheet to between the downstream-side conveyance roller 6 and the spur 7a and, in turn, a cause of jam (paper jam). This may occur after the sheet passes through the upstream-side conveyance roller 2 and before it reaches the downstream-side conveyance roller 6 and, particularly, may be a conspicuous problem when the sheet comes close to the downstream-side conveyance roller 6.

Hence, in this embodiment, when printing the reverse surface, intermittent conveyance and scan printing during the time after the sheet passes through the upstream-side conveyance roller 2 and before it reaches the downstream-side conveyance roller 6 are at least partially changed from intermittent conveyance and scan printing during other times.

FIG. 4 is a schematic sectional view concerning a region including the printhead 5, the upstream-side conveyance roller 2, and the downstream-side conveyance roller 6 in the printing apparatus 50. The printhead 5 scanned in the X direction at the time of scan printing includes a plurality of nozzles NZ that are arrayed in the Y direction and can discharge ink. In one scan printing, a region according to an array length L1 of the nozzles NZ can be printed at once.

Here, in this embodiment, the plurality of nozzles are divided into three groups, that is, a first nozzle group GNZa, a second nozzle group GNZb, and a third nozzle group GNZc from the upstream side to the downstream side. At this time, a length L2 of each of the nozzle groups GNZa to GNZc can be expressed as

L2=L1/3

In this configuration, the conveyance amount (intermittent conveyance amount) of one intermittent conveyance can be changed depending on which one of the nozzle groups GNZa to GNZc is to be driven. In this embodiment, one scan printing is performed by selecting one of two types of print modes below.

### —Normal Mode

The intermittent conveyance amount is set to L1, and all the nozzle groups GNZa to GNZc are driven.

### —Low-Speed Mode

The intermittent conveyance amount is set to L2 (=L1/3), and one of the nozzle groups GNZa to GNZc is driven.

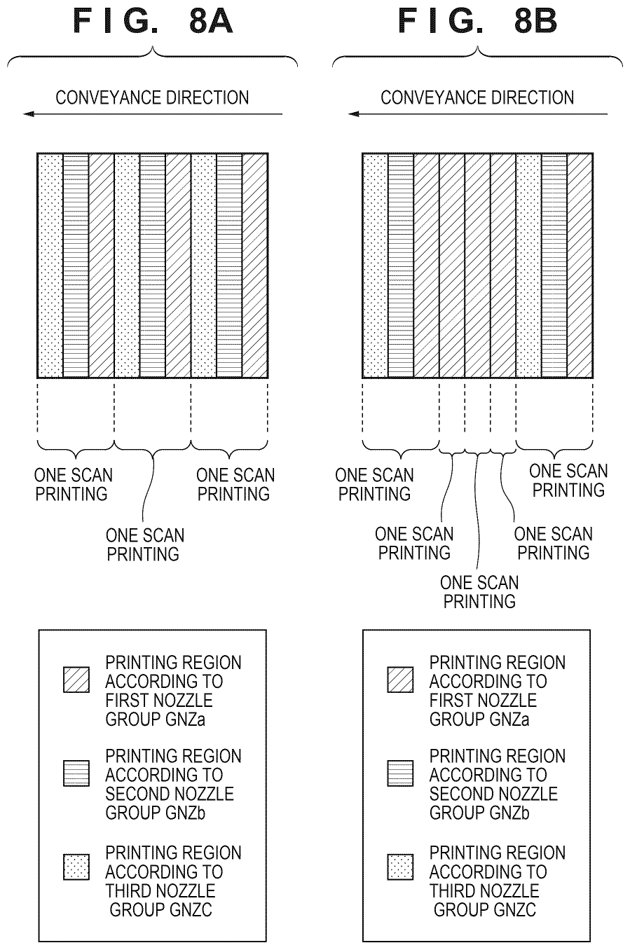

Details will be described later with reference to FIG. 8A, and the like.

Note that in this embodiment, 192 nozzles NZ are arrayed in the Y direction at an interval of 600 dots per inch (dpi), and each of the nozzle groups GNZa to GNZc includes 64 nozzles NZ.

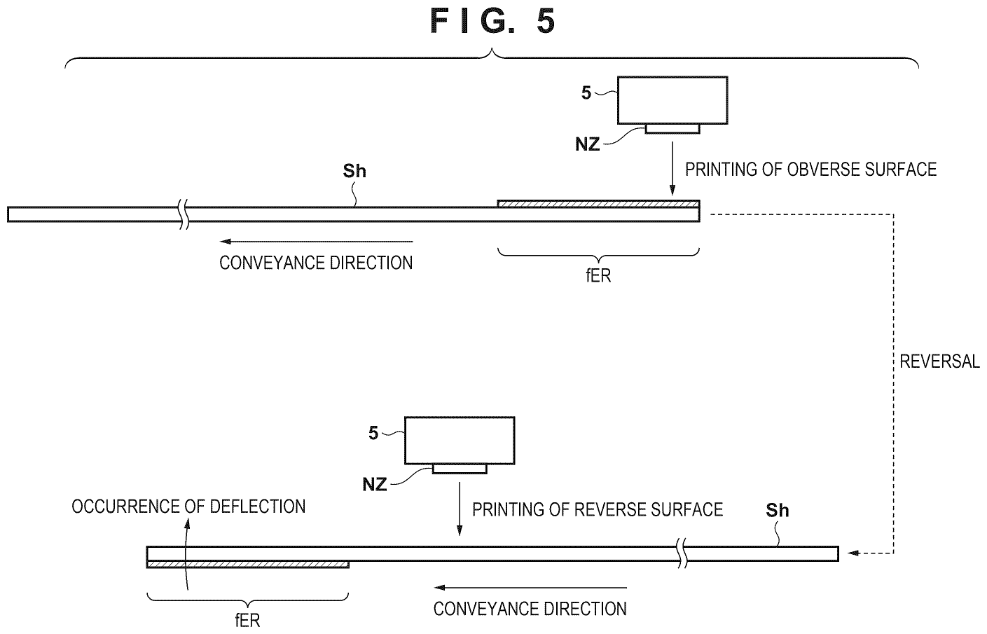

FIG. 5 is a schematic view for explaining a printing region on each of the obverse surface side and the reverse surface side of a sheet Sh. An upstream-side edge region when printing the obverse surface is defined as an obverse surface trailing edge region (first edge region) fER. The obverse surface trailing edge region fER changes to a downstream-side edge region when printing the reverse surface and therefore corresponds to a reverse surface leading edge region. Depending on the ink discharge amount in the obverse surface trailing edge region fER, when printing the reverse surface, the sheet Sh may be slightly deflected after the sheet Sh passes through the upstream-side conveyance roller 2 and before it reaches the downstream-side conveyance roller 6.

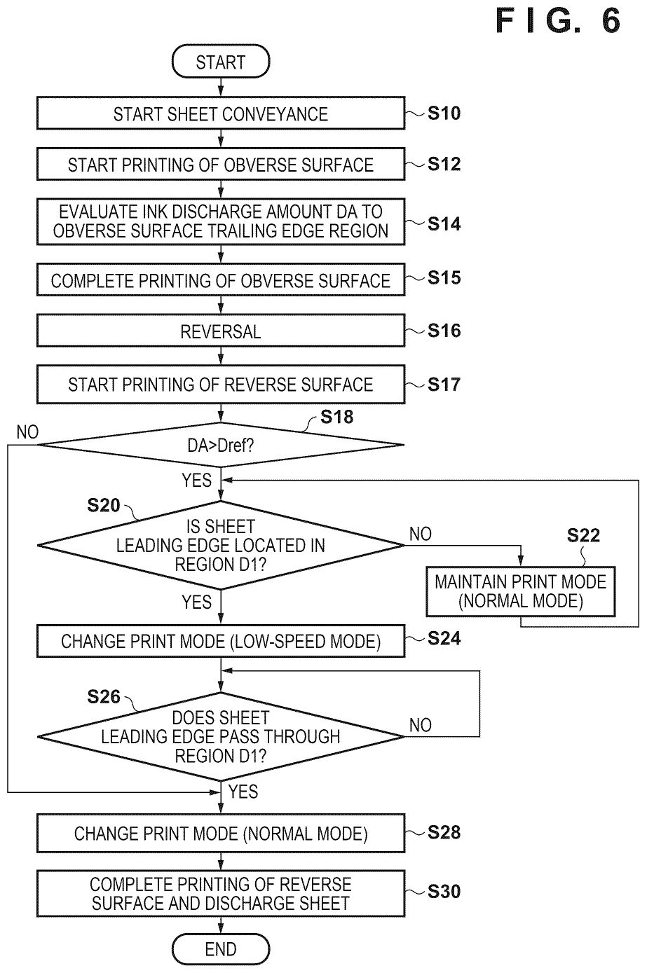

FIG. 6 is a flowchart showing an example of a method of print control to appropriately implement double-sided printing in such a case. This flowchart is started when, for example, print data is received from the host computer 214. First, print data received by the MPU 201 is analyzed, and the start of a printing operation is decided. The MPU 201 executes each process of the flowchart.

In step S10 (to be simply referred to as “S10” hereinafter, and this also applies to remaining steps to be described later), conveyance of a sheet is started. Note that the number of sheets to be taken as the print target from the paper feed unit 51 into the apparatus main body by the paper feed roller 1 is two or more in some cases, but to facilitate the explanation, it is assumed below that a single sheet is taken into the apparatus main body.

In S12, printing on the obverse surface of the taken sheet is started. This printing is started when the sheet sensor 12 detects the sheet reaching the upstream-side conveyance roller 2 and the sheet is conveyed to a position (print start position) where the printhead 5 can start printing, and is performed in the above-described normal mode.

In S14, while continuing printing on the obverse surface, the ink discharge amount to the obverse surface trailing edge region fER is evaluated as an ink discharge amount DA. Note that since the ink discharge amount DA in S14 needs to be found out until S18, S14 may be performed at another timing.

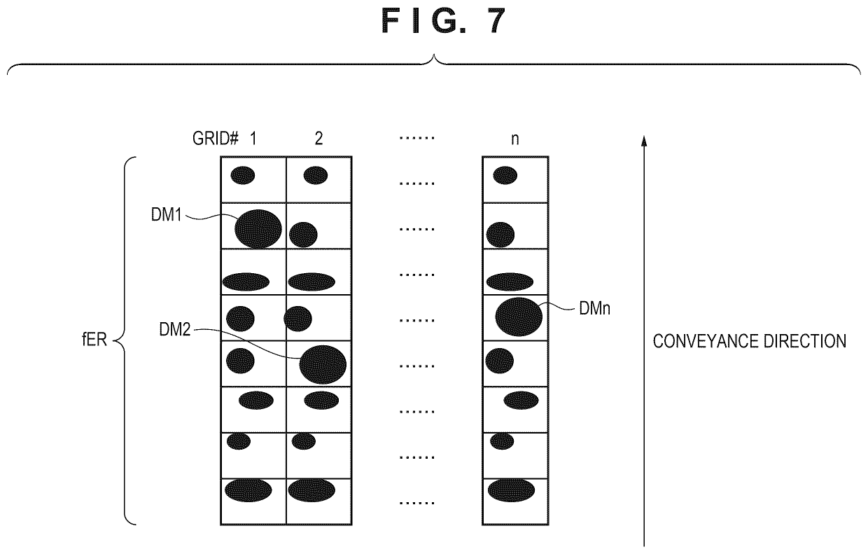

FIG. 7 is a schematic view showing an example of a method of evaluating the ink discharge amount DA in the obverse surface trailing edge region fER. Evaluation of the ink discharge amount DA can be done by dividing the region fER into a plurality of grids and calculating the ink discharge amount in each grid. As an example, the region fER is divided into grids corresponding to n columns each along the conveyance direction of the sheet (n is an integer of 2 or more). For example, for the first grid, the number of ink dots in each of several regions arranged in the conveyance direction is calculated and, for example, the maximum value is calculated as an ink discharge amount DM1. For the second to nth grids, ink discharge amounts DM2 to DMn are calculated in accordance with the same procedure as described above.

Based on the thus calculated ink discharge amounts DM1 to DMn, the ink discharge amount in the obverse surface trailing edge region fER is evaluated as the ink discharge amount DA and calculated as the average value of the ink discharge amounts DM1 to DMn in this embodiment. That is,

$$DA = \sum DMk / n ( k = 1 to n )$$

can be obtained.

Referring back to FIG. 6, when printing on the obverse surface is completed in S15, in S16, the sheet with the printed obverse surface is conveyed to the reversal conveyance mechanism 53 by reversely rotating the conveyance roller 2 (and additionally the conveyance roller 6) and thus reversed (see FIG. 2B).

In S17, the reversed sheet is conveyed to the conveyance roller 2 again by the relay roller 13 and conveyed to the print start position of the printhead 5, and printing on the reverse surface of the reversed sheet is started in accordance with this. Printing on the reverse surface is started at the same conveyance speed as in printing of the obverse surface, that is, in the normal mode.

In S18, it is determined whether the ink discharge amount DA acquired in accordance with the procedure described with reference to FIG. 7 is greater than a reference amount Dref. If the ink discharge amount DA is greater than the reference amount Dref, the process advances to S20. Otherwise, the process advances to S28.

In S20, it is determined whether the sheet leading edge in printing on the reverse surface is located in a predetermined mode switching region D1. If the sheet leading edge reaches and enters the mode switching region D1, the process advances to S24. Otherwise, the process advances to S22.

Referring back to FIG. 4, the mode switching region D1 can be set within the range from the upstream side of the spur 7b to the downstream side such that at least the spur 7b is included. In addition, since the sheet need only reach the conveyance roller 6 such that it passes at least between the conveyance roller 6 and the spur 7a, the mode switching region D1 can be set within the range from the upstream side of the spur 7b to the conveyance roller 6. In the viewpoint of the sheet, when viewed in the direction (Z direction) facing the platen 4, when printing the reverse surface, the obverse surface trailing edge region fER overlaps the entire spur 7b at a timing immediately before the sheet reaches the conveyance roller 6.

Note that in this embodiment in which 192 nozzles NZ are arrayed at an interval of 600 dpi (dots per inch), the mode switching region D1 can be set within the range from a position 5 mm (millimeters) on the upstream side of the spur 7b to a position 3 mm on the downstream side of the spur 7b.

Referring to FIG. 6, in S22, printing in the normal mode to be described later in detail with reference to FIG. 8A is continued, and the process returns to S20.

In S24, the print mode is switched, and printing in the low-speed mode to be described later in detail with reference to FIG. 8B is performed.

In S26, it is determined whether the sheet leading edge in printing on the reverse surface passes through the mode switching region D1. In this embodiment, as described above, the sheet leading edge is specified based on the detection result of the leading edge detection sensor 91 and the detection result of the optical sensor. If the sheet leading edge passes through the mode switching region D1, the process advances to S28. Otherwise, the process returns to S26 to continue printing in the low-speed mode until the sheet leading edge passes through the mode switching region D1.

In S28, the print mode is switched, and printing in the normal mode is performed again. That is, printing in the low-speed mode is performed during passage of the sheet through the mode switching region D1, and printing in the normal mode is performed in the remaining periods.

In accordance with completion of printing on the reverse surface in S30, the sheet whose obverse surface and reverse surface are both printed is discharged to the discharge unit 52, and the flowchart is ended.

FIG. 8A is a schematic view showing a state in which printing in the normal mode is continued. That is, in the normal mode, intermittent conveyance with the intermittent conveyance amount L1 and scan printing in which all the nozzle groups GNZa to GNZc are driven are repetitively performed.

FIG. 8B is a schematic view showing a state in which printing in the low-speed mode is partially performed. In the low-speed mode, intermittent conveyance with the intermittent conveyance amount L2 (=L1/3) and scan printing in which one of the nozzle groups GNZa to GNZc is driven are repetitively performed. In the low-speed mode, the sheet easily moves to between the conveyance roller 6 and the spur 7a because of the small conveyance amount in one operation and position deviation of printing hardly occurs because of the small region in one scan printing.

In this embodiment in which the printhead 5 is a serial head that alternately performs intermittent conveyance of the sheet and scan printing, the conveyance speed of the sheet corresponds to the intermittent conveyance amount of the sheet.

For example, the conveyance speed is an average speed obtained based on the conveyance amount when intermittent conveyance is performed a plurality of times for this. In this example, the conveyance speed for the normal mode shown in FIG. 8A corresponds to a value obtained by dividing the conveyance amount L1 by the sum of the time used for conveyance with the conveyance amount L1 and the time used for scan printing corresponding to this. Similarly, the conveyance speed for the low-speed mode shown in FIG. 8B corresponds to a value obtained by dividing the conveyance amount L2 by the sum of the time used for conveyance with the conveyance amount L2 and the time used for scan printing corresponding to this.

Note that in this embodiment, conveyance of the sheet is performed by trapezoidal drive, and the highest conveyance speed (the maximum value of the conveyance speed) at this time substantially remains unchanged between the normal mode and low-speed mode, but is not limited to this. For example, the highest speed in the normal mode may be higher than that in the low-speed mode.

Here, in this embodiment, in the low-speed mode, the nozzle group GNZa on the most upstream side is driven in the nozzle groups GNZa to GNZc. Immediately before the sheet reaches the downstream-side conveyance roller 6, floating of the sheet can be suppressed on the upstream side more than on the downstream side. It is therefore preferable that the nozzle group GNZa is driven in the low-speed mode.

According to this embodiment, if the reverse surface leading edge region is relatively slightly deflected in printing on the reverse surface because of the relatively large ink discharge amount DA in the obverse surface trailing edge region fER, printing on the reverse surface is at least partially performed in the low-speed mode. This makes it possible to make the conveyance amount in one operation and the region of one scan printing small, and suppress position deviation of printing, and also prevent occurrence of a jam and appropriately implement double-sided printing.

### SUMMARY

According to this embodiment, when printing the reverse surface of the sheet, the upstream-side conveyance roller 2 changes the conveyance speed in accordance with the ink discharge amount DA in the obverse surface trailing edge region fER of the sheet until the sheet reaches the downstream-side conveyance roller 6. For example, if the ink discharge amount DA in the obverse surface trailing edge region fER is greater than the reference amount Dref, when printing the reverse surface, the reverse surface leading edge region corresponding to the obverse surface trailing edge region fER may be relatively slightly deflected. In this embodiment, printing on the reverse surface until the sheet reaches the downstream-side conveyance roller 6 can be performed in the low-speed mode in which the conveyance speed is at least partially relatively low.

On the other hand, if the ink discharge amount DA in the obverse surface trailing edge region fER is less than the reference amount Dref and greater than another reference amount Dref (<Dref), the sheet may be conveyed at a conveyance speed lower than in the normal mode and higher than in the low-speed mode. For example, as a quasi low-speed mode, the intermittent conveyance amount may be set to L3 (=L1× 2/3), and two of the nozzle groups GNZa to GNZc may be driven.

In this embodiment, a mode has been exemplified in which if the ink discharge amount DA in the obverse surface trailing edge region fER is relatively large, printing on the reverse surface is at least partially performed in the low-speed mode. However, if the ink discharge amount DA is relatively small, printing on the reverse surface may be performed in the normal mode. That is, based on the ink discharge amount DA, the print mode is switched, and the conveyance speed of the sheet is changed.

In this embodiment in which the printhead 5 is a serial head that alternately performs intermittent conveyance of the sheet and scan printing, the conveyance speed of the sheet corresponds to the intermittent conveyance amount of the sheet. That is, if the ink discharge amount DA in the obverse surface trailing edge region fER is greater than the reference amount Dref, printing on the reverse surface is performed in the low-speed mode, and the intermittent conveyance amount at that time can be set to a value less than in the normal mode.

In this embodiment, a case where the printhead 5 is a serial head has been exemplified. As another embodiment, the printhead 5 may be a line head extended over the whole sheet width. In this case, the sheet is conveyed not by intermittent conveyance but at a substantially constant speed with respect to the line head, and the conveyance speed is changed in accordance with the ink discharge amount DA in the obverse surface trailing edge region fER. At this time, the interval of ink discharge from the line head is adjusted in accordance with the changed conveyance speed.

The contents of arithmetic processing exemplified in this embodiment may partially be changed without departing from the scope of the present disclosure. For example, some of the steps described with reference to FIG. 6 may partially be replaced without departing from the scope of the present disclosure.

### Second Embodiment

In the flowchart of FIG. 6, S12 (the start of printing on the obverse surface) and S17 (the start of printing on the reverse surface) are executed in accordance with the conveyance of the sheet to the print start position of a printhead 5, as described above. Printing by the printhead 5 is started generally at a timing after the elapse of a predetermined period after the sheet reaches the print start position of the printhead 5. That is, in this embodiment, an MPU 201 in FIG. 3 interrupts sheet conveyance and waits during a wait time from the timing at which the sheet reaches the print start position of the printhead 5 to the timing at which the printhead 5 actually starts printing.

The wait time can be provided as an operation preparation period of the printhead 5. In double-sided printing or in a case where printing is continuously performed a plurality of times, the wait time can also be provided as a period for cooling a power source such as motors 204 and 205 in FIG. 3, which may be heated upon the printing. For example, if the temperature of the power source is higher than a reference temperature, the wait time is set long, and this can be performed based on the detection result of a temperature sensor 206.

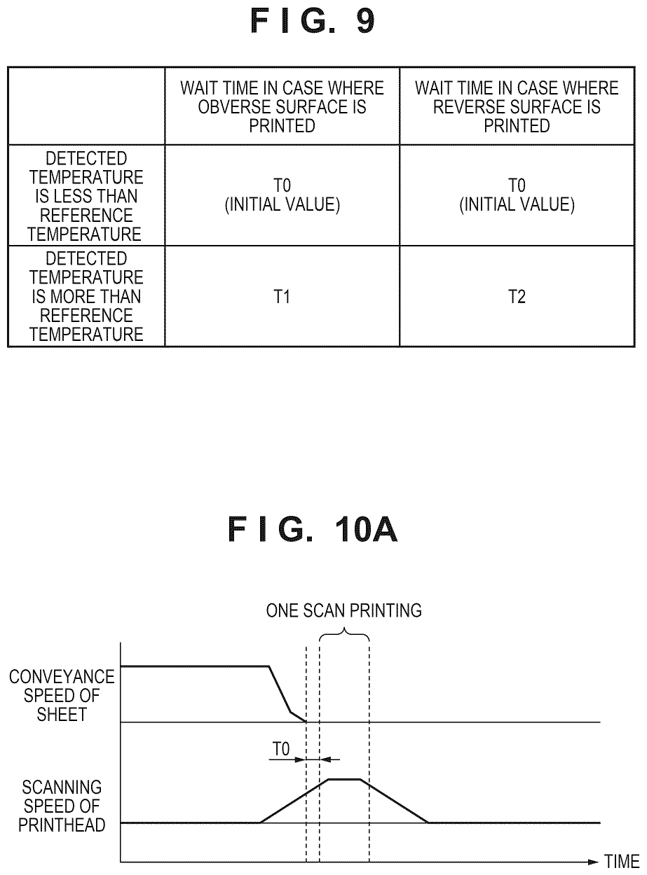

FIG. 9 shows a list showing wait times in printing on the obverse surface and wait times in printing on the reverse surface. These can be set in accordance with the detection result of the temperature sensor 206. The wait times can individually set for a case where the obverse surface is printed and for a case where the reverse surface is printed.

In this embodiment, the wait time is set to time TO (for example, 0.1 sec) that is an initial value in both the case of printing on the obverse surface and the case of printing on the reverse surface. When printing the obverse surface, if the detected temperature of the temperature sensor 206 is higher than the reference temperature, the wait time can be reset or changed to time T1 (for example, 10 sec). Also, when printing the reverse surface, if the detected temperature of the temperature sensor 206 is higher than the reference temperature, the wait time can be reset or changed to time T2 (for example, 1 second). That is, the wait time can be set longer in a case where the detected temperature reaches the reference temperature than otherwise.

As another embodiment, the wait time may be set for each detected temperature of the temperature sensor 206 and, for example, may divisionally be set for three or more cases.

The above-described deflection of the sheet described in the first embodiment may be eliminated by the wait time. Hence, as an example, if the wait time is longer than a reference time, steps from S18 may be omitted (it is not necessary to shift to the low-speed mode). As another example, a reference amount Dref referred to in S18 may be changed or adjusted in accordance with the wait time.

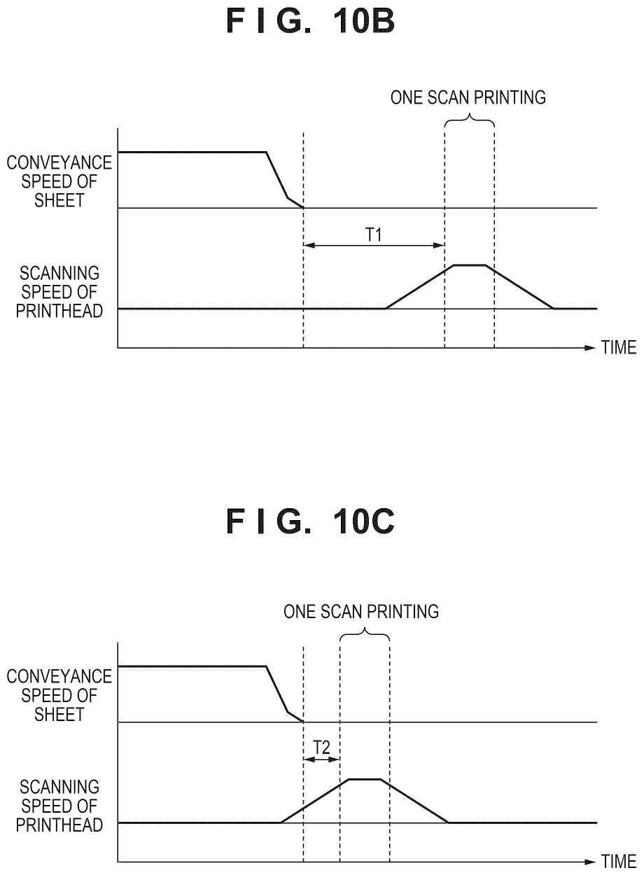

FIGS. 10A, 10B, and 10C are timing charts showing, for each of the wait times T0, T1, and T2, the relative relationship between the change of the sheet conveyance speed and the change of the scanning speed of the printhead 5 in the first scan printing at the start of printing. The abscissa corresponds to the time base, and the ordinate indicates the conveyance speed of the sheet (the conveyance speed by conveyance rollers 2 and 6) and the scanning speed of the printhead 5 (the moving speed of a carriage 10).

In one scan printing, printing is started after the scanning speed of the printhead 5 increases to a substantially maximum value, and after the printing is completed, the scanning speed of the printhead 5 decreases to zero. Printing need only be started after the conveyance speed decreases to zero (that is, after the conveyance of the sheet is stopped). Hence, the timing of starting acceleration of the printhead 5 is adjusted in accordance with the wait time.

For example, in the example shown in FIG. 10A (wait time TO (0.1 second in this example)), after the conveyance speed decreases to zero, the scanning speed of the printhead 5 reaches a substantially maximum value in a relatively short time. Hence, the timing of starting acceleration of the printhead 5 can be before the timing of starting deceleration of the conveyance rollers 2 and 6. On the other hand, in the example shown in FIG. 10B (wait time T1 (10 seconds in this example)), the timing of starting acceleration of the printhead 5 can be after the timing of stopping the conveyance rollers 2 and 6.

### <<Program>>

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

### <<Others>>

In the above explanation, the printing apparatus 50 using the inkjet printing method has been described as an example. However, the printing method is not limited to the above-described mode. Also, the printing apparatus 50 may be a single-function printer having only a printing function or may be a multi-function printer having a plurality of functions such as a printing function, a FAX function, and a scanner function. Also, for example, the printing apparatus may be a manufacturing apparatus configured to manufacture a color filter, an electronic device, an optical device, a microstructure, or the like by a predetermined printing method.

Also, “print” in this specification should be interpreted in a broader sense. Hence, the mode of “print” is usable regardless of whether a target formed on a print medium is significant information such as a character or graphic pattern and also regardless of whether the information has become obvious to allow human visual perception.

“Print media” should also be interpreted in a broader sense, like “print”. Hence, the concept of “print media” can include not only paper used in general but also any members capable of accepting ink, including fabrics, plastic films, metal plates, glass, ceramic, resins, wood, and leather materials.

Furthermore, “ink” should also be interpreted in a broader sense, like “print”. Hence, the concept of “ink” can include not only a liquid that is applied to a print medium to form an image, a design, a pattern, or the like but also an incidental liquid that can be provided to process a print medium or process ink (for example, coagulate or insolubilize color materials in ink applied to a print medium).

Also, in the embodiments, each element is named using an expression based on its main function. However, each function described in the embodiments may be a sub-function, and is not strictly limited to the expression. The expression can be replaced with a similar expression. In the same vein, an expression “unit or portion” can be replaced with “tool”, “component”, “member”, “structure”, “assembly”, or the like. Alternatively, these may be omitted or added.

In addition, two or more elements selectably exemplified in the embodiments are not strictly limited to the exemplification, and may arbitrarily be combined. For example, each of the two or more elements exemplified may be additionally selected or alternatively selected. As an example, when arbitrarily combining two elements A and B, to indicate one of “only A”, “only B”, and “both A and B”, an expression “A and/or B” may be used, or an expression “at least one of A and B” may be used.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-080374, filed May 16, 2024, which is hereby incorporated by reference herein in its entirety.

What is claimed is:

1. A printing apparatus comprising:
a first conveyance unit configured to convey a print medium;
a printing unit configured to perform printing by discharging ink to a first surface of the print medium conveyed by the first conveyance unit and a second surface opposite to the first surface;
a second conveyance unit configured to convey the print medium printed by the printing unit; and
a reversal conveyance unit configured to reverse the print medium whose first surface is printed by the printing unit and convey the print medium to the first conveyance unit to print the second surface by the printing unit,
wherein an edge region on an upstream side in a conveyance direction in a case that the printing unit performs printing on the first surface is defined as a first edge region, and
in a case that the printing unit performs printing on the second surface of the print medium with the printed first surface, a conveyance speed of the print medium until the print medium from the reversal conveyance unit reaches the second conveyance unit changes depending on an ink discharge amount in the first edge region.

2. The apparatus according to claim 1, wherein
if the ink discharge amount in the first edge region is greater than a reference amount, the first conveyance unit decreases the conveyance speed of the print medium with the printed first surface.

3. The apparatus according to claim 2, wherein
the printing unit is a serial head that alternately performs intermittent conveyance of the print medium by at least one of the first conveyance unit and the second conveyance unit and scan printing for the print medium, and the conveyance speed of the print medium corresponds to an intermittent conveyance amount of the print medium.

4. The apparatus according to claim 1, wherein
the first conveyance unit is arranged on the upstream side in the conveyance direction with respect to the printing unit, and
the second conveyance unit is arranged on a downstream side in the conveyance direction with respect to the printing unit.

5. The apparatus according to claim 4, further comprising:
a platen configured to support the print medium that should be printed by the printing unit; and
a spur configured to regulate the print medium arranged between the printing unit and the second conveyance unit to a side of the platen,
wherein when viewed in a direction facing the platen, the first edge region is set to overlap the entire spur at a timing immediately before the print medium when the printing unit performs printing on the second surface reaches the second conveyance unit.

6. The apparatus according to claim 1, further comprising:
a driving unit configured to drive at least one of the first conveyance unit and the second conveyance unit; and
a detection unit configured to detect a temperature of the driving unit,
wherein the first conveyance unit interrupts conveyance of the print medium and waits during a wait time from a timing at which the print medium reaches a position where the printing unit can start printing to a timing at which the printing unit actually starts printing, and the wait time is set based on a detection result of the detection unit.

7. The apparatus according to claim 6, wherein
the wait time is set longer in a case where the temperature of the driving unit detected by the detection unit reaches a reference temperature than otherwise.

8. The apparatus according to claim 7, wherein
the wait time is individually set for a case where the first surface is printed and for a case where the second surface is printed.

9. A control method of a printing apparatus including:
a first conveyance unit configured to convey a print medium;
a printing unit configured to perform printing by discharging ink to a first surface of the print medium conveyed by the first conveyance unit and a second surface opposite to the first surface;
a second conveyance unit configured to convey the print medium printed by the printing unit; and
a reversal conveyance unit configured to reverse the print medium whose first surface is printed by the printing unit and convey the print medium to the first conveyance unit to print the second surface by the printing unit,
the method comprising:
performing printing on the first surface of the print medium by the printing unit;
reversing the print medium with the printed first surface by the reversal conveyance unit; and
performing printing on the second surface of the print medium by the printing unit,
wherein an edge region on an upstream side in a conveyance direction in a case that the printing unit performs printing on the first surface is defined as a first edge region, and
in the performing printing on the second surface, a conveyance speed of the print medium until the print medium from the reversal conveyance unit reaches the second conveyance unit changes depending on an ink discharge amount in the first edge region.

10. A non-transitory computer-readable storage medium storing a program, the program configured to cause a computer to execute a control method of a printing apparatus including:
a first conveyance unit configured to convey a print medium;
a printing unit configured to perform printing by discharging ink to a first surface of the print medium conveyed by the first conveyance unit and a second surface opposite to the first surface;
a second conveyance unit configured to convey the print medium printed by the printing unit; and
a reversal conveyance unit configured to reverse the print medium whose first surface is printed by the printing unit and convey the print medium to the first conveyance unit to print the second surface by the printing unit,
the method comprising:
performing printing on the first surface of the print medium by the printing unit;
reversing the print medium with the printed first surface by the reversal conveyance unit; and
performing printing on the second surface of the print medium by the printing unit,
wherein an edge region on an upstream side in a conveyance direction in a case that the printing unit performs printing on the first surface is defined as a first edge region, and
in the performing printing on the second surface, a conveyance speed of the print medium until the print medium from the reversal conveyance unit reaches the second conveyance unit changes depending on an ink discharge amount in the first edge region.
